(19) United States
(12) Patent Application Publication
(10) Pub. No.: US 2019/0086205 A1
(43) Pub. Date: Mar. 21, 2019

(54) Wearable fitness band that measures the circumference of arms, legs, and other body parts

(71) Applicant: Justin Paul Franks, Grapevine, TX (US)

(72) Inventor: Justin Paul Franks, Grapevine, TX (US)

(21) Appl. No.: 16/138,828

(22) Filed: Nov. 29, 2018

Related U.S. Application Data
(60) Provisional application No. 62/561,538, filed on Sep. 21, 2017.

(51) Int. Cl. G01B 21/32; A63B 24/00

(52) U.S. Cl. CPC G01B 21/32; A63B 24/0062; A63B 2225/50; A63B 2220/836; A63B 2220/20

(57) ABSTRACT

Wearable fitness band that measures the circumference of arms, legs, and other body parts is disclosed. This invention is a wearable product that can be used during an exercising session. This product can expand and contract as the users muscles expand and contract, while actively measuring circumference.

### BACKGROUND OF THE INVENTION

### Problem Solved

For bodybuilders, trainers, and other fitness related individuals, one form of evaluating progression and goals is to track the physical changes in size of a body part. The conventional approach typically includes using a fabric measuring tape similar to the ones used by tailors, to measure a body part and evaluate growth (or reduction as desired). Typically this is done pre-performance or post-performance of an exercise session. For the dedicated athlete however this may fall short of their needs. Some athletes would benefit from evaluating if an exercise/resistance level is providing enough muscle fiber engagement during performance to immediately react to the current level of exertion.

The conventional approach typically includes using a fabric measuring tape similar to the ones used by tailors, to measure a body part and evaluate growth (or reduction as desired). Typically this is done pre-performance or post-performance of an exercise session.

This invention is a wearable product that can be used during an exercising session. This product can expand and contract as the users muscles expand and contract, while actively measuring circumference.

### BRIEF DESCRIPTION OF THE DRAWINGS

FIG. 1 is front elevational view of a schematic of a wearable fitness band for measuring the circumference of a body part constructed in accordance with particular embodiments of the invention; and

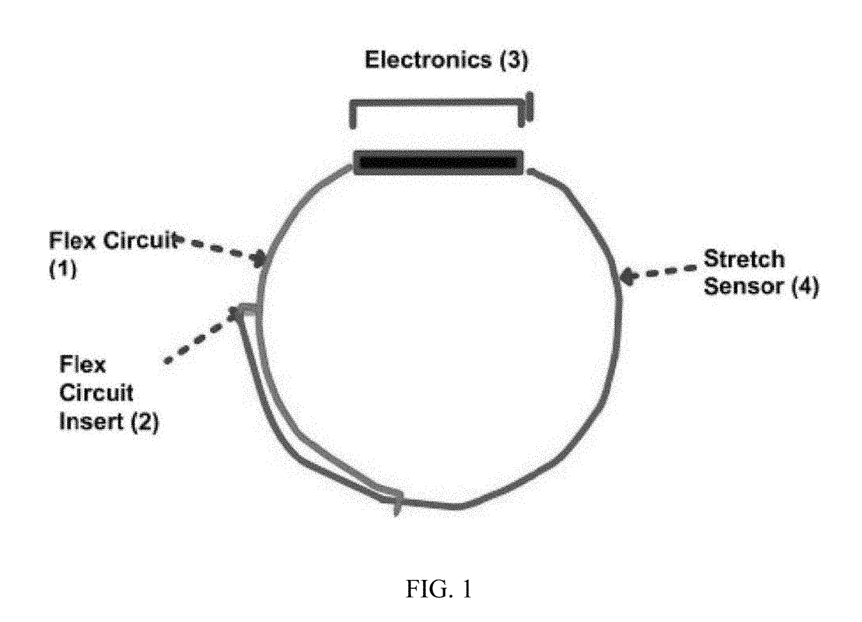

FIG. 2 is a top plan view of a wear a wearable fitness band for measuring the circumference of a body part constructed in accordance with particular embodiments of the invention.

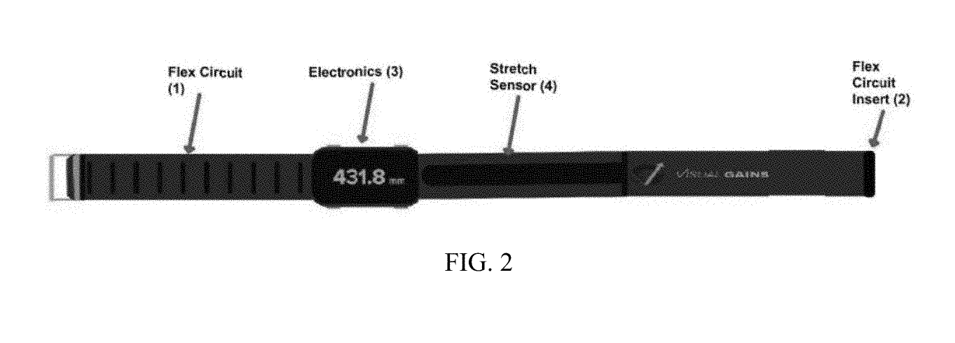

### DETAILED DESCRIPTION OF THE INVENTION

As stated above, for bodybuilders, trainers, and other fitness related individuals, one form of evaluating progression and goals is to track the physical changes in size of a body part. The conventional approach typically includes using a fabric measuring tape similar to the ones used by tailors, to measure a body part and evaluate growth (or reduction as desired). Typically this is done pre-performance or post-performance of an exercise session. For the dedicated athlete however this may fall short of their needs.

Some athletes would benefit from evaluating if an exercise/resistance level is providing enough muscle fiber engagement during performance to immediately react to the current level of exertion. The invention claimed here solves this problem.

This invention is designed to measure the circumference of a person's limb (i.e. arm, leg) while the person is actively exercising and while the person's limb expands and contracts.

The claimed invention differs from what currently exists. This invention is the only wearable product in this field that a person can use while they are active (exercising).

This invention is an improvement on what currently exists. This invention is the only wearable product in this field that a person can use while they are active (exercising).

For the dedicated athlete however this may fall short of their needs. Some athletes would benefit from evaluating if an exercise/resistance level is providing enough muscle fiber engagement during performance to immediately react to the current level of exertion.

This invention is a wearable product that can be used during an exercising session. This product can expand and contract as the users muscles expand and contract, while actively measuring circumference.

### The Version of the Invention Discussed Here Includes:

1. Flex circuit
2. Flex circuit insert
3. Electronics
4. Stretch sensor

### Relationship Between the Components:

The Flex circuit insert (2) can be inserted or connected to the Flex circuit (1) at pre-determined fixed positions. The Stretch sensor (4) is connected to the Electronics (3) and is elastic. The Electronics (3) compute a live measurement and display the measurement and/or communicate the measurement to a personal device (i.e. smart phone, tablet, computer, smart watch, or other personal device).

### How the Invention Works:

The Flex circuit insert (2) is inserted or connected to the Flex circuit (1) establishing a fixed measurement. The Stretch sensor (4) measures the expanding and contracting measurement providing a variable measurement. The stretch sensor is a sensor that can measure the length of stretch and it expands and contracts. Electronics (3) are configured to calculate a circumference of the body part from the fixed measurement established by the flex circuit (1) and by the variable measurement established by the Stretch sensor (4); and a display connected to the electronics (3) will display the calculated circumference of the body part and/or communicate the measurement wirelessly to a personal device (i.e. smart phone, tablet, computer, smart watch, or other personal device).

### How to Make the Invention:

Assemble the elements as described above. Manufacture the electronics; flex circuit, stretch sensor, and other parts. Procure the screen, battery, Bluetooth components, other components and parts and prepare for assembly. Program the electronics and user interface.

The device could be made without a screen using a connect device (i.e. personal device, smart watch) to show the measurement. The device could also be made without Bluetooth, relying solely on the screen to show measurement.

### How to Use the Invention:

A fitness enthusiast would wear this invention while exercising (i.e. lifting weights) to track the size of his/her arm (or other limb) while they workout. They can set goals to achieve a certain size, and the invention will inform the user when they achieve their goal. This product will also show the users size while at rest or while flexing at various stages of their exercise routine.

1. A wearable fitness band that measures a change in the dimension of a body part comprising:
a flex circuit;
a stretch sensor coupled to the flex circuit for sensing a change in dimension of the stretch sensor; and
electronics coupled to the stretch sensor for computing and displaying a measurement of the change of dimension of the stretch sensor that correlates to the change of dimension of the body part.

2. The fitness band of claim 1, further comprising:
a flex circuit insert that couples to the flex circuit at a selected fixed position to establish a fixed measurement.

3. A method of measuring a change in dimension of a body part comprising:
positioning a wearable fitness band around a body part to be measured, the fitness band having a stretch sensor assembly for computing and displaying a measurement of the change of dimension of the stretch sensor that correlates to a change in the dimension of the body part; and
measuring a change of dimension of the body part using the fitness band.

4. The method of claim 3, wherein:
the wearable fitness band comprises:
a flex circuit;
a stretch sensor coupled to the flex circuit for sensing a change in dimension of the stretch sensor; and
electronics coupled to the stretch sensor for computing and displaying a measurement of the change of dimension of the stretch sensor.

5. The method of claim 4, wherein:
the wearable fitness band further comprises a flex circuit insert that couples to the flex circuit at a selected fixed position to establish a fixed measurement.
